(19) United States
(12) Patent Application Publication
(10) Pub. No.: US 2006/0213030 A1
(43) Pub. Date: Sep. 28, 2006

(54) Hinge

(75) Inventors: Sheng-Nan Lu, Shulin City (TW); Chung-Yu Lee, Shulin City (TW); Jia-Hao Hsu, Shulin City (TW)

Correspondence Address: NIKOLAI & MERSEREAU, P.A., 900 SECOND AVENUE SOUTH, SUITE 820, MINNEAPOLIS, MN, 55402, US

(73) Assignee: SHIN ZU SHING CO., LTD., Shulin City (TW)

(21) Appl. No.: 11/369,036

(22) Filed: Mar. 6, 2006

(30) Foreign Application Priority Data
Mar. 10, 2005 (TW) 094203703

(51) Int. Cl. E05D 7/00

(52) U.S. Cl. 16/221

(57) ABSTRACT

A hinge has a shaft, a rotating bracket, a stationary bracket, a rotating positioning element and a stationary positioning element. The rotating bracket is mounted securely on the shaft and is attached to a cover of an electrical appliance. The stationary bracket is mounted around the shaft and is attached to a base of the electrical appliance. The rotating positioning element is mounted securely on the shaft and has two positioning protrusions. The stationary positioning element is mounted securely on the stationary bracket and has two positioning detents. The positioning detents selectively engage the positioning protrusions to keep the cover from bumping against the base.

### BACKGROUND OF THE INVENTION

1. Field of the Invention

The present invention relates to a hinge, especially to a hinge is mounted in an electrical appliance to allow a cover of the electrical appliance rotating in relative to a base of the electrical appliance.

2. Description of the Prior Arts

Electrical appliances such as notebook computers comprise a cover with a LCD, a base and a hinge. The hinge is mounted between the cover and the base to allow the cover rotating in relative to the base. However, the cover easily bumps against the base when the cover is closed, especially when the cover with a larger LCD. The bumping causes the LCD broken easily.

To overcome the shortcomings, the present invention provides a hinge with positioning function to mitigate or obviate the aforementioned problems.

### SUMMARY OF THE INVENTION

The main objective of the present invention is to provide a hinge with positioning function. The hinge has a shaft, a rotating bracket, a stationary bracket, a rotating positioning element and a stationary positioning element. The rotating bracket is mounted securely on the shaft and is attached to a cover of an electrical appliance. The stationary bracket is mounted around the shaft and is attached to a base of the electrical appliance. The rotating positioning element is mounted securely on the shaft and has two positioning protrusions. The stationary positioning element is mounted securely on the stationary bracket and has two positioning detents. The positioning detents selectively engage the positioning protrusions to keep the cover from bumping against the base.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a hinge in accordance with the present invention;

FIG. 2 is an exploded perspective view of the hinge in FIG. 1;

FIG. 3 is a partial end view of the hinge in FIG. 1;

FIG. 4 is an operational end view of the hinge in FIG. 1 with a cover opened in relative to a base of an electrical appliance;

FIG. 5 is an operational end view of the hinge in FIG. 1 with the cover opened in relative to the base of the electrical appliance; and

FIG. 6 is an operational end view of the hinge in FIG. 1 with the cover opened in relative to the base of the electrical appliance.

### DETAILED DESCRIPTION OF THE PREFERRED EMBODIMENTS

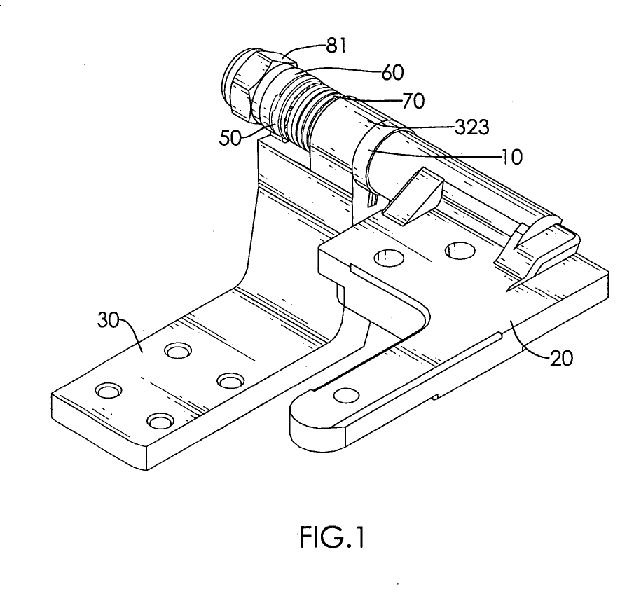

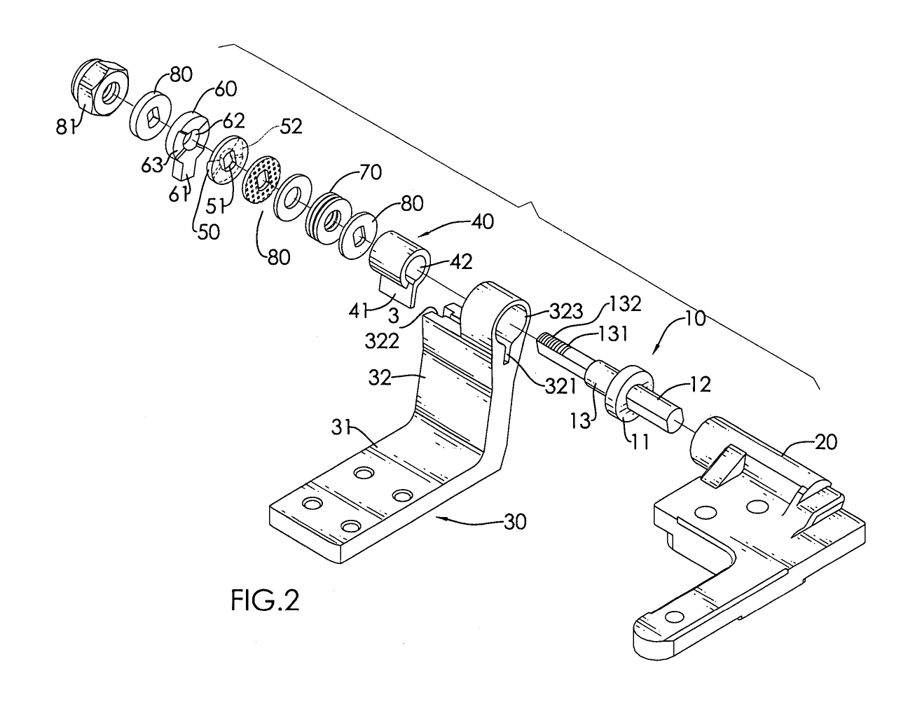

With reference to FIGS. 1 and 2, a hinge in accordance with the present invention comprises a shaft (10), a rotating bracket (20), a stationary bracket (30), a resilient sleeve (40), a rotating positioning element (50), a stationary positioning element (60), a biasing member (70), at least one washer (80) and a fastener (90).

The shaft (10) has a head (11), a fastening rod (12), an assembling rod (13), a mounting rod (131) and an optional thread (132). The head (11) has a first side and a second side. The fastening rod (12) is formed axially on the first side of the head (11) and is non-circular. The assembling rod (13) is formed axially on the second side of the head (11) and has a distal end. The mounting rod (131) is formed axially on the distal end of the assembling rod (13) and is non-circular. The thread (132) is formed on the mounting rod (131).

The rotating bracket (20) is mounted securely on fastening rod (12) of the shaft (10).

The stationary bracket (30) is L-shaped, is mounted around the assembling rod (13) of the shaft (10) and has a fastening wing (31), a mounting wing (32), a mounting sleeve (323), an optional recess (321) and an optional notch (322). The mounting wing (32) is perpendicular to the fastening wing (31) and has a top surface, a first side and a second side. The mounting sleeve (323) is formed on the top surface of the mounting wing (32) and is adjacent to the first side of the mounting wing (32). The recess (321) is formed in the top surface of the mounting wing (32), is adjacent to the first side of the mounting wing (32) and communicates with the mounting sleeve (323). The notch (322) is formed in the top surface of the mounting wing (32), is adjacent to the second side of the mounting wing (32) and communicates with and is wider than the recess (321).

The resilient sleeve (40) is mounted around the mounting rod (131) of the shaft (10), is mounted securely in the mounting sleeve (323) of the stationary bracket (30) and has a sleeve segment (42). The resilient sleeve (40) may be 9-shaped and may have a fastening protrusion (41). The sleeve segment (42) is mounted around the mounting rod (131) of the shaft (10) and corresponds to the mounting sleeve (323) of the stationary bracket (30). The fastening protrusion (41) is formed radially on the sleeve segment (42) and is mounted securely in the recess (321) of the stationary bracket (30).

The rotating positioning element (50) is mounted securely on the mounting rod (131) of the shaft (10) and has a first side, a non-circular through hole (51) and two positioning protrusion (52). The through hole (51) is formed through the rotating positioning element (50) and is mounted securely on the mounting rod (131) of the shaft (10). The positioning protrusions (52) are formed separately in the first side of the rotating positioning element (50) and may be opposite to each other.

The stationary positioning element (60) is mounted around the mounting rod (131) of the shaft (10), is mounted securely on the stationary bracket (30) and has a first side, a central circular hole (62), two positioning detents (63) and an optional fastening protrusion (61). The first side of the stationary positioning element (60) faces the first side of the rotating positioning element (50). The positioning detents (63) are formed in the first side of the stationary positioning element (60) and correspond respectively to and selectively engage the positioning protrusions (52) of the rotating positioning element (50). The fastening protrusion (61) is formed radially on the stationary positioning element (60) and is mounted securely in the notch (322) of the stationary bracket (30).

The biasing member (70) and the washer (80) are mounted around the shaft (10). The fastener (81) is mounted securely on the mounting rod (131) and may be a nut to screw on the thread (132) of the shaft (10).

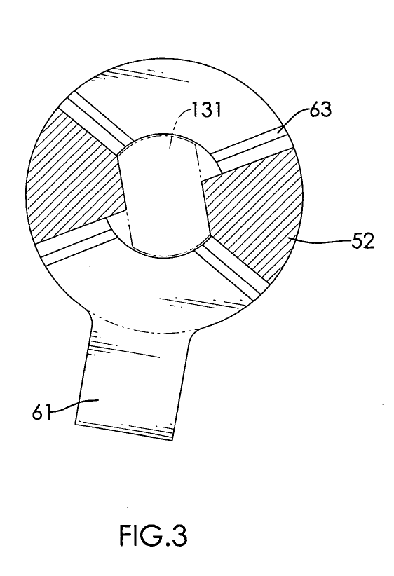

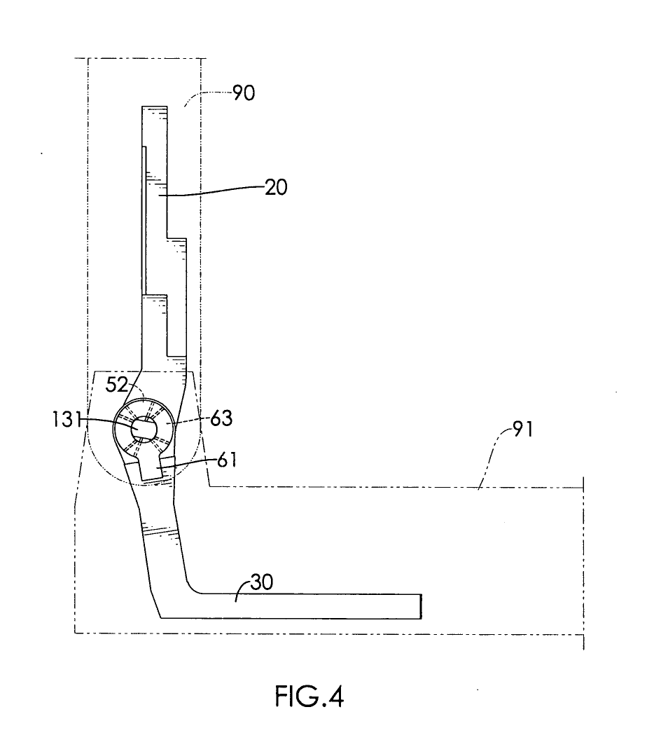

With further reference to FIGS. 3 and 4, the hinge as described is mounted in an electrical appliance with a cover (90) and a base (91). The rotating bracket (20) is attached to the cover (90). The stationary bracket (30) is attached to the base (91). When the cover (90) rotates in relative to the base (91), the rotating bracket (20) rotates the shaft (10) and the rotating positioning element (50) is also rotated.

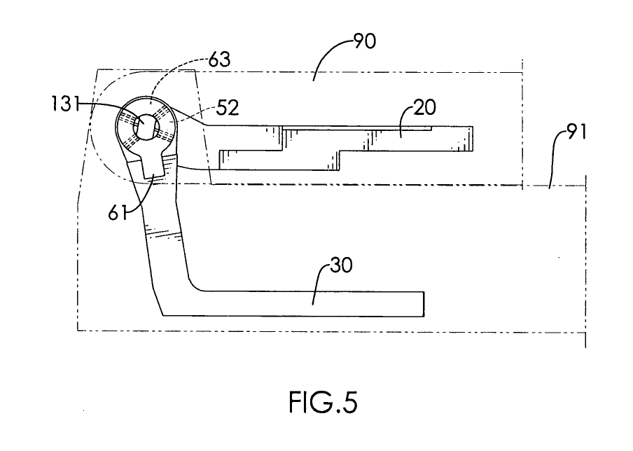

With further reference to FIG. 5, the cover (90) is closed. The positioning protrusions (52) of the rotating positioning element (50) respectively engage the positioning detents (63) of the stationary positioning element (60) to provide positioning function to keep the cover (90) from bumping against the base (91). Then a LCD on the cover (90) will not be broken easily.

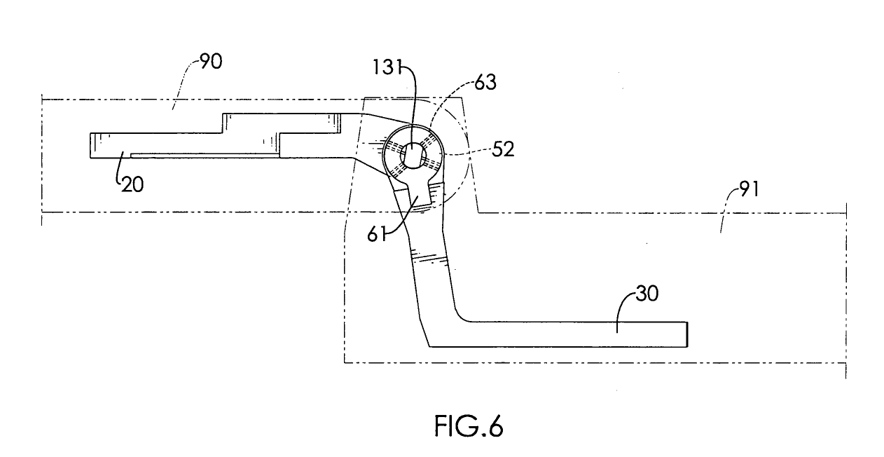

With further reference to FIG. 6, the cover (90) is opened and is included 180 degrees with the base (91). Because the positioning protrusions (52) of the rotating positioning element (50) are oppositely to each other, the positioning protrusions (52) of the rotating positioning element (50) engage respectively to the positioning detents (63) of the stationary positioning element (60) when the cover (90) is opened and is included 180 degrees with the base (91). Therefore, the cover (90) will not be overturn when the cover (90) is opened.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge comprising:
a shaft having
a head having a first side and a second side;
a fastening rod formed axially on the first side of the head and being non-circular;
an assembling rod formed axially on the second side of the head and having a distal end; and
a mounting rod formed axially on the distal end of the assembling rod and being non-circular;
a rotating bracket mounted securely on fastening rod of the shaft;
a stationary bracket being L-shaped, mounted around the assembling rod of the shaft and having
a fastening wing;
a mounting wing being perpendicular to the fastening wing and having a top surface, a first side and a second side; and
a mounting sleeve formed on the top surface of the mounting wing and being adjacent to the first side of the mounting wing;
a resilient sleeve mounted around the mounting rod of the shaft, mounted securely in the mounting sleeve of the stationary bracket and having a sleeve segment mounted around the mounting rod of the shaft and corresponding to the mounting sleeve of the stationary bracket;
a rotating positioning element mounted securely on the mounting rod of the shaft and having
a first side;
a non-circular through hole formed through the rotating positioning element and mounted securely on the mounting rod of the shaft; and
two positioning protrusion formed separately in the first side of the rotating positioning element;
a stationary positioning element mounted around the mounting rod of the shaft, mounted securely on the stationary bracket and having
a first side facing the first side of the rotating positioning element;
a central circular hole; and
two positioning detents formed in the first side of the stationary positioning element and corresponding respectively to and selectively engaging the positioning protrusions of the rotating positioning element;
a biasing member mounted around the shaft;
at least one washer mounted around the shaft; and
a fastener mounted securely on the mounting rod of the shaft.

2. The hinge as claimed in claim 1, wherein the positioning protrusions of the rotating positioning element are oppositely to each other.

3. The hinge as claimed in claim 1, wherein
the stationary bracket has
a recess formed in the top surface of the mounting wing, being adjacent to the first side of the mounting wing and communicating with the mounting sleeve; and
a notch formed in the top surface of the mounting wing, being adjacent to the second side of the mounting wing and communicating with and being wider than the recess;
the resilient sleeve has a fastening protrusion formed radially on the sleeve segment and mounted securely in the recess of the stationary bracket; and
the stationary positioning element has a fastening protrusion formed radially on the stationary positioning element and mounted securely in the notch of the stationary bracket.

4. The hinge as claimed in claim 2, wherein
the stationary bracket has
a recess formed in the top surface of the mounting wing, being adjacent to the first side of the mounting wing and communicating with the mounting sleeve; and
a notch formed in the top surface of the mounting wing, being adjacent to the second side of the mounting wing and communicating with and being wider than the recess;
the resilient sleeve has a fastening protrusion formed radially on the sleeve segment and mounted securely in the recess of the stationary bracket; and
the stationary positioning element has a fastening protrusion formed radially on the stationary positioning element and mounted securely in the notch of the stationary bracket.

5. The hinge as claimed in claim 1, wherein
the shaft has a thread formed on the mounting rod; and
the fastener is a nut to screw on the thread of the shaft.

6. The hinge as claimed in claim 4, wherein
the shaft has a thread formed on the mounting rod; and
the fastener is a nut to screw on the thread of the shaft.
